(19) United States
(12) Patent Application Publication
(10) Pub. No.: US 2012/0312453 A1
(43) Pub. Date: Dec. 13, 2012

(54) SYSTEM FOR FORMING A FIRE RESISTANT WALL STRUCTURE, AND ASSOCIATED METHOD

(75) Inventor: Daniel Baroux, Nanaimo (CA)

(73) Assignee: BLMH Technologies Inc.

(21) Appl. No.: 13/448,981

(22) Filed: Apr. 17, 2012

Related U.S. Application Data
(63) Continuation of application No. PCT/CA2010/001637, filed on Oct. 19, 2010.
(60) Provisional application No. 61/253,437, filed on Oct. 20, 2009.

(51) Int. Cl. B32B 7/12; B32B 37/12

(52) U.S. Cl. 156/71; 428/343

(57) ABSTRACT

A system is provided for forming a fire resistant wall structure from a wall having an exposed combustible component. A sheet member comprising cellulose fibers is interacted with a fire-retarding substance, wherein the fire-retarding substance is substantially uniformly distributed about the sheet member so as to render the sheet member substantially ignition-resistant. The sheet member has a major surface adapted to receive an aesthetic surface treatment, and is configured to be applied to the wall to at least partially cover the exposed combustible component. An adhesive material is configured to be applied between the sheet member and the wall so as to secure the sheet member to the wall, such that the major surface of the sheet member is exposed and so as to substantially prevent atmospheric oxygen from interacting with the combustible component. An associated method is also provided.

### CROSS-REFERENCE TO RELATED APPLICATIONS

This application is a continuation of International Application No. PCT/CA2010/001637, filed Oct. 19, 2010, which International Application was published by the International Bureau in English on Apr. 28, 2011, and claims priority to U.S. Provisional Patent Application No. 61/253,437, filed Oct. 20, 2009, all of which are incorporated herein by reference in their entirety and for all purposes.

### BACKGROUND OF THE DISCLOSURE

1. Field of the Disclosure

Aspects of the present disclosure relate to systems and methods for forming fire resistant products, and, more particularly, to a system for forming a fire resistant wall structure, and associated method.

2. Description of Related Art

It may sometimes be desirable for particular products to exhibit resistance to fire. For example, it may be desirable for paperboard products used in building construction to exhibit a certain degree of fire resistance. In the case of drywall, which generally comprises a gypsum core with paperboard facing sheets, it is the gypsum core, and not the paperboard facing sheets, which is relied upon to provide some fire resistance capabilities. However, since drywall is comprised of two different materials, it may be difficult and/or relatively expensive to produce. Further, the fire resistance capabilities of drywall may not necessarily be enough to make a significant difference in the overall construction of the building.

One significant impediment to implementing cellulose products, such as the paperboard facing sheets of a drywall product, on a widespread basis is the risk of fire. That is, though cellulose products may be implemented in many different applications, those applications may be precluded by the apparent lack of fire resistance provided by such cellulose products. In some instances, a paperboard product may have a fire-retardant product applied thereto, post-formation, to provide some fire resistance capabilities for the paperboard product. That is, an exemplary as-formed paperboard product may have a surface treatment, for example, a liquid fire retardant, applied thereto in order for the treated product to exhibit at least some fire resistance. In such cases, however, one possible limitation in the treatment of the as-formed paperboard product for fire resistance, particularly with a liquid fire retardant, is achieving an even and consistent treatment of that product. More particularly, the result of some fire resistance treatment processes involving application of a liquid fire-retardant to an as-formed paperboard product may be an uneven or otherwise inconsistent coverage of the fire retardant with respect to the product. In those instances, the uneven treatment may result in varying levels of fire resistance of the treated paperboard product which may, in turn, become a hazard in the event of a fire, which the product is intended to retard or otherwise provide some resistance against. Further, such treatment processes may not necessarily be efficient in terms of applying the fire retardant to the paperboard product. In addition, even with as-formed cellulose products treated with a liquid fire retardant, the treated product may not necessarily be heat resistant. That is, even if the as-formed cellulose product, treated with a liquid fire retardant, were to be locally fire resistant, the associated heat may break down the cellulose and allow the fire to penetrate the product.

From another perspective, drywall is often the basis of a wall structure configured to receive an overlying aesthetic treatment. Paint and/or primer substances are examples of such an aesthetic treatment that may be applied to the drywall as a surface finish. In some instances, the aesthetic treatment may comprise wallpaper, a fabric, or other suitable decorative material. However, wall structures, such as interior walls or other building surfaces which have had an aesthetic treatment applied thereto (i.e., paint or wallpaper), can become a fire hazard depending, for example, on the particular type of aesthetic treatment used. One issue with such aesthetic treatments is that, if it is desired to change the appearance of the wall structure, a subsequent aesthetic treatment may be applied directly over the preceding aesthetic treatment. For instance, it may not be uncommon to encounter a surface of a wall structure has been repainted or re-wallpapered several times and, as such, is covered with multiple layers of paint and/or wallpaper. In the event of a fire, such layers of paint and/or wallpaper may provide additional sources of fuel for the fire. In some instances, such layers may facilitate or otherwise encourage the spread of flame along the surface of the wall structure. Flame spread, in some particular instances, may be a significant contributing factor to the severity of some structure fires.

In light of such issues, one possible resolution could be to remove the old/multiple layers of paint and/or wallpaper from the wall structure or other surface, in order to reduce the fire hazard. However, removal of multiple layers of paint/wallpaper can be time consuming and expensive, and can possibly pose a health risk to the workers doing the removal, particularly when removing layers of lead-based paint. As such, in order to avoid such drawbacks associated with the removal of multiple layers of paint/wallpaper, the subject wall structures may sometimes have the entire drywall or sheet material sheath removed therefrom, also necessarily removing the paint/wallpaper layers disposed thereon, down to the supporting wall studs. The wall studs may then be resurfaced with new drywall or other sheet material. It is apparent, though, that such measures may also be time consuming and expensive, and still may not necessarily address the issue of fire resistance of the resulting wall structure.

Thus, there exists a need for a process and associated system for rendering a wall structure having an exposed combustible component into a fire-resistant and/or ignition-resistant wall structure, while minimizing or eliminating the need for extensive rework or renovation of that wall structure. Such a solution should also provide for an even and consistent application of a fire retardant to a cellulose product such as, for example, a paperboard product and/or a fiber board product, to attain an enhanced level of fire resistance and/or ignition resistance.

### BRIEF SUMMARY OF THE DISCLOSURE

The above and other needs are met by aspects of the present disclosure, wherein one such aspect relates to a system for forming a fire resistant wall structure from a wall having an exposed combustible component. Such a system comprises a sheet member comprising cellulose fibers interacted with a fire-retarding substance. The fire-retarding substance is substantially uniformly distributed about the sheet member so as to render the sheet member substantially ignition-resistant. The sheet member has a major surface adapted to receive an aesthetic surface treatment, and is configured to be applied to the wall to at least partially cover the exposed combustible component. An adhesive material is configured to be applied between the sheet member and the wall so as to secure the sheet member to the wall, such that the major surface of the sheet member is exposed and so as to substantially prevent atmospheric oxygen from interacting with the combustible component.

Another aspect of the present disclosure relates to a method for forming a fire resistant wall structure from a wall having an exposed combustible component. Such a method comprises applying a sheet member to the wall to at least partially cover the exposed combustible component, wherein the sheet member comprises cellulose fibers interacted with a fire-retarding substance. The fire-retarding substance is substantially uniformly distributed about the sheet member so as to render the sheet member substantially ignition-resistant. The sheet member also includes a major surface adapted to receive an aesthetic surface treatment. An adhesive material is applied between the sheet member and the wall so as to secure the sheet member to the wall, such that the major surface of the sheet member is exposed and so as to substantially prevent atmospheric oxygen from interacting with the combustible component.

In some aspects, a seam-sealing element is configured to be applied to adjacent sheet members secured to the wall and defining a seam therebetween, wherein the seam-sealing element is configured to cover the seam and to cooperate with the sheet members to cover the exposed combustible component. The seam-sealing element may also be interacted with the fire-retarding substance, such that the fire-retarding substance is substantially uniformly distributed about the seam-sealing element, and is rendered ignition-resistant. The seam-sealing element may also include a major surface adapted to receive an aesthetic surface treatment and in such instances, may be configured to be applied to the adjacent sheet members to cover the seam therebetween while exposing the major surface of the seam-sealing element.

The adhesive material may also comprise the fire-retarding substance, wherein the fire-retarding substance may be substantially uniformly distributed with respect to the adhesive material so as to render the adhesive material ignition-resistant.

The sheet member may also include between about 2% and about 30% solids content of the fire-retarding substance. The cellulose fibers forming the sheet member may also be processed from one of raw wood pulp, palm tree waste, waste fiber, waste paper, and waste board. The sheet member may comprise, for example, one of an encasement paper sheet member, a medium density fiber (MDF) board sheet member, and an oriented strand board (OSB) sheet member.

The fire-retarding substance may comprise one of a boron compound, a borate, an inorganic hydrate, a bromine compound, aluminum hydroxide, magnesium hydroxide, hydromagnesite, antimony trioxide, a phosphonium salt, ammonium phosphate, diammonium phosphate, and combinations thereof Generally, the fire-retarding substance may comprise one of an aqueous fire-retarding solution, a nontoxic liquid fire-retarding solution, and a neutral pH liquid fire-retarding solution. That is, in particular aspects, the fire-retarding substance may be an aqueous fire-retarding solution, or it may be preferred that the fire-retarding solution be nontoxic and/or have a neutral pH and/or be hypoallergenic and/or have any number of otherwise desirable properties.

In some instances, the sheet member may further comprise one of a mold inhibitor, a water resistance treatment, and an insect deterrent. In particular instances, the sheet member may further comprise an insect deterrent, comprising one of glass particles and a borate substance, so as to provide a termite deterrent.

Aspects of the present disclosure thus address the identified needs and provide other advantages as otherwise detailed herein.

### BRIEF DESCRIPTION OF THE SEVERAL VIEWS OF THE DRAWINGS

Having thus described the disclosure in general terms, reference will now be made to the accompanying drawings, which are not necessarily drawn to scale, and wherein:

FIG. 1 schematically illustrates a partial cross-section of a wall structure comprising a sheath layer covered by one or more aesthetic treatment layers, with the outermost exposed aesthetic treatment layer being covered by a sheet member, according to one aspect of the disclosure;

FIG. 2 schematically illustrates a sheet member wound on or into a roll, according to one aspect of the disclosure;

FIG. 3 schematically illustrates a method of interacting the rolled sheet member with a fire-retarding substance, according to one aspect of the disclosure;

FIG. 4 schematically illustrates a method of interacting a sheet member with a fire-retarding substance, according to another aspect of the disclosure;

FIG. 5 schematically illustrates an apparatus for distributing a fire-retarding substance about a sheet member, according to one aspect of the disclosure;

FIG. 6 schematically illustrates a partial cross-section of a wall structure comprising a sheath layer covered by one or more aesthetic treatment layers, with the outermost exposed aesthetic treatment layer being covered by a sheet member, with an adhesive material disposed therebetween, according to one aspect of the disclosure; and

FIG. 7 schematically illustrates a front view of a wall structure having an outermost exposed aesthetic treatment layer partially covered by adjacent sheet members defining a seam therebetween, wherein the seam is sealed by a seam-sealing element, according to one aspect of the disclosure.

### DETAILED DESCRIPTION OF THE DISCLOSURE

The present disclosure now will be described more fully hereinafter with reference to the accompanying drawings, in which some, but not all aspects of the disclosure are shown. Indeed, the disclosure may be embodied in many different forms and should not be construed as limited to the aspects set forth herein; rather, these aspects are provided so that this disclosure will satisfy applicable legal requirements. Like numbers refer to like elements throughout.

As discussed herein, drywall is often the basis of a wall structure configured to receive an overlying aesthetic treatment, wherein paint and/or primer substances, wallpaper, a fabric, or other suitable decorative material, may be examples of such an aesthetic treatment that may be applied as a surface finish to the drywall or other existing surface of the wall structure. However, wall structures, such as interior walls or other building surfaces which have had an aesthetic treatment applied thereto (i.e., paint or wallpaper), can become a fire hazard depending, for example, on the particular type of aesthetic treatment used. One issue with such aesthetic treatments is that, if it is desired to change the appearance of the wall structure, a subsequent aesthetic treatment may be applied directly over the preceding aesthetic treatment. For instance, it may not be uncommon to encounter a surface of a wall structure has been repainted or re-wallpapered several times and, as such, is covered with multiple layers of paint and/or wallpaper. In the event of a fire, such layers of paint and/or wallpaper may provide additional sources of fuel for the fire. In some instances, such layers may facilitate or otherwise encourage the spread of flame along the surface of the wall structure. Flame spread, in some particular instances, may be a significant contributing factor to the severity of some structure fires. Often times, however, removing the old/multiple layers of paint and/or wallpaper from the wall structure, or removing and replacing the entire drywall or sheet material sheath, can be time consuming and expensive, and can possibly pose a health risk, Further, such measures still may not necessarily address the issue of fire resistance of the resulting wall structure.

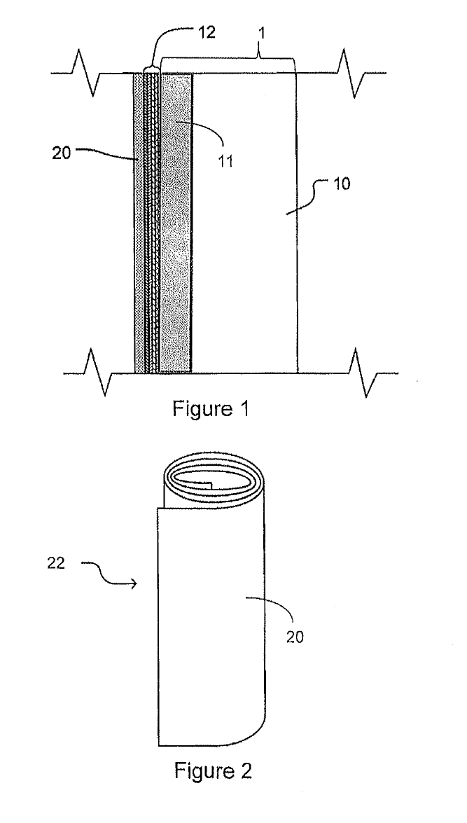

One aspect of the present disclosure is thus related to a system and method for forming a fire resistant wall structure from a wall having an exposed combustible component. In this regard, FIG. 1 illustrates a cross-sectional portion of a wall 1 having a framing structure 10 covered by sheathing 11 such as, for example, drywall, plywood, or OSB. In some instances, the outwardly-facing surface of the sheathing 11 may be covered with one or more layers 12 of an aesthetic treatment, such as paint and/or wallpaper. The most outwardly disposed of the aesthetic treatment layers 12, or even the sheathing 11 itself (if no aesthetic material layer 12 is present), may comprise the exposed combustible component(s). As such, according to aspects of the disclosure, in order to form a fire resistant wall structure in which the wall structure is resistant to fire originating from the aesthetic treatment side of the sheathing 11, a sheet member 20 is engaged with the outermost exposed aesthetic treatment layer 12.

In some instances, the sheet member 20 may be comprised of cellulose fibers. In some particular aspects, the sheet member 20 may comprise cellulose fibers interacted with a fire-retarding substance. In such instances, the fire-retarding substance is substantially uniformly distributed about the sheet member so as to render the sheet member substantially ignition-resistant, heat resistant, fire-resistant, fireproof, and/or fire-retarding.

As previously discussed, one possible limitation in the treatment of as-formed cellulose products, such as a paperboard product, for fire resistance, is achieving a substantially even and consistent treatment of that cellulose product. More particularly, the result of some fire resistance surface-treatment processes may be an uneven or otherwise inconsistent application of the fire retardant to the cellulose product. In those cases, such uneven surface treatment may result in varying levels of fire resistance of the treated cellulose product which may, in turn, become a hazard in the event of a fire which the product is intended to retard or otherwise provide some resistance against In addition, even if such as-formed cellulose products were to be treated with a fire retardant, the treated product may not necessarily be heat resistant (i.e., may not provide a thermal barrier in case of fire). That is, even if the as-formed cellulose product, treated with a liquid fire retardant, were to be locally fire resistant, the associated heat may break down the cellulose and allow the fire to penetrate the product.

As such, one aspect of the present disclosure involves appropriately interacting or otherwise treating the cellulose fibers with the fire-retarding substance, as the sheet member 20 is being formed. More particularly, in some instances, the cellulose fibers may be processed into a fiber mixture, wherein a fire-retarding solution (and/or water and/or other appropriate liquid or chemical) may then be added to the fiber mixture to form a slurry. The slurry may be agitated or otherwise mixed, as necessary, such that the fire-retarding solution is substantially uniformly distributed therethrough, and the slurry then formed into a cellulose product, such as the sheet member 20. The cellulose fibers may be obtained from one or more sources to form the fiber mixture. Further, aspects of the present disclosure contemplate that the cellulose fibers may comprise recycled cellulose fibers (i.e., from raw wood pulp, palm tree waste, waste paper, waste board, waste paperboard, or any other suitable waste source of cellulose fibers, already used to form a product and suitable for recycling), though one skilled in the art will appreciate that raw, original, or otherwise virgin cellulose fibers may also be used in addition to, in combination with, or instead of the recycled/waste cellulose fibers. For example, sawmill waste and/or empty fruit baskets/bunches from palm trees or other palm tree waste may be suitable sources of previously unprocessed cellulose fibers for refining, as necessary, to obtain cellulose fibers for the fiber mixture. Further, in some aspects, the cellulose fibers may not necessarily be required to be free of contaminants, as long as those contaminants can be processed/refined along with the cellulose material to refine the cellulose fibers into a form suitable for the fiber mixture. As such, a decontamination process may not necessarily be contemplated, but could be included, should there be a need or desire for a contaminant-free fiber mixture for inclusion in the cellulose product (i.e., sheet member 20). The extent of the processing/refining of the cellulose materials may vary considerably depending, for example, on the level of refinement (i.e., coarse/fine) desired of the fiber mixture and/or the final cellulose product (i.e., sheet member 20).

In addition, the cellulose fibers do not necessarily need to be dry prior to being processed. That is, waste sources of cellulose fibers may be, in some instances, in the form of bales, wherein the bales may often be exposed to the elements (i.e., rain or condensation) prior to being processed. In those instances, aspects of the present disclosure contemplate the “wet” source of cellulose fibers being processed into the fiber mixture. That is, the cellulose fibers may be processed, regardless of the moisture level present therein, into the fiber mixture. Any moisture content present in the fiber mixture upon processing may be taken into account, for example, in subsequent preparation of the slurry (i.e., the amount of water or other liquid used) for forming the cellulose product (i.e., sheet member 20).

In particular aspects, the fire-retarding solution comprising the fire-retarding substance may be an aqueous fire-retarding solution. It may be preferred that the fire-retarding solution be nontoxic and/or have a neutral pH and/or be hypoallergenic and/or have any number of otherwise desirable properties affecting human/animal and/or environmental safety, while maintaining the necessary efficacy, as implemented and upon exposure to heat and/or flame. In some aspects, the fire-retarding solution/fire-retarding substance may comprise any one of a boron compound, a phosphorus compound, a borate, an inorganic hydrate, a bromine compound, aluminum hydroxide, magnesium hydroxide, hydromagnesite, antimony trioxide, a phosphonium salt, ammonium phosphate, diammonium phosphate, and various combinations thereof, and/or other known fire-retarding substances. In this regard, one skilled in the art will appreciate that various fire-retarding or fire-resistant or ignition-resistant substances, either currently known or later developed or discovered, may be applicable to the disclosed processes and systems herein within the scope of the present disclosure.

One skilled in the art will further appreciate that the fire-retarding solution may be formed by adding a solid fire-retardant product to a liquid (i.e., water) or other chemical mixed with the fiber mixture such that the solid fire-retardant product forms a solution with the liquid or other chemical comprising the slurry with the fiber mixture. In some instances, the slurry or pulp mixture may be agitated so as to substantially uniformly distribute the fire-retarding solution therethrough.

The slurry, once prepared, may then be formed into the sheet member 20, for example, using a conventional paper making process, using paper making machinery available, for instance, from Siempelkamp of Dusseldorf, Germany or Metso Paper, Inc. of Helsinki, Finland. More particularly, the slurry may be dewatered, for example, by a suitable Fourdrinier-type machine, using a twin wire forming section and/or appropriate screening devices, or by another appropriate paper making process, as will be appreciated by one skilled in the art. The dewatered slurry may then be dried, pressed, or otherwise processed to form the cellulose product. To form the cellulose product, such as the sheet member 20, heat may also be applied to the slurry, for example, via heated air (i.e., heated with combusted natural gas or other suitable fuel source), or through any of a variety of heating/drying methods, such as, for example, microwave or infrared drying techniques, as will be appreciated by one skilled in the art.

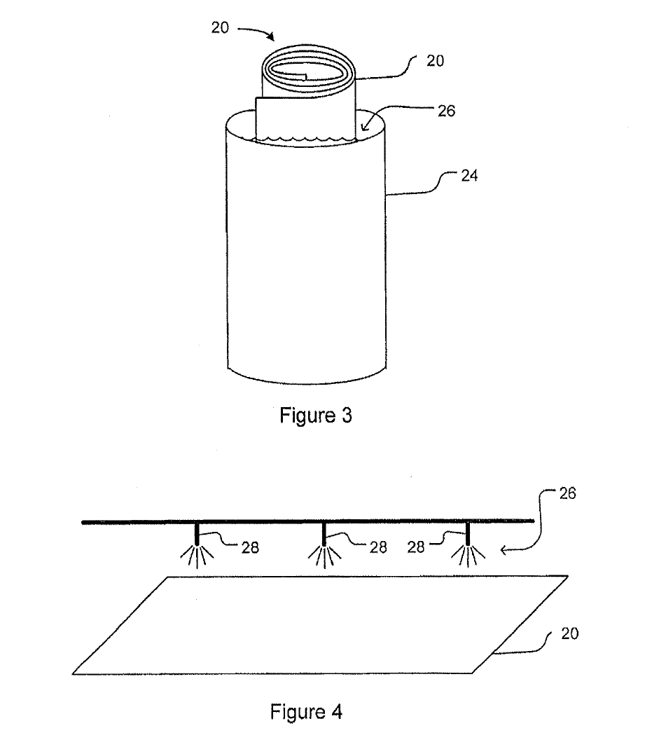

In other aspects of the present disclosure, the cellulose sheet member 20 may be formed, for example, as previously disclosed, but without inclusion of the fire-retarding substance. Once the sheet member 20 is formed, the fire-retarding substance may be applied thereto in different manners to treat the sheet member for fire- and/or ignition-resistance. For example, in some instances, as shown in FIG. 2, the sheet member 20 may be wound on or into a roll 22 to facilitate storage and shipment. In such cases, the sheet member 20 may comprise, for instance, heavy paper stock, encasement paper, or otherwise relatively heavy grade paper or paperboard material. The thickness, weight, and/or grade of the paper stock may be selected in accordance with different factors, such as, for example, the type and size of the surface to be covered or the nature of the combustible component disposed thereon. Thicker paper stock may be selected to provide increased protection against fire/ignition, and/or to provide increased resistance to heat. The minimum thickness/weight/grade, in some aspects may be, for example, 10 lb paper stock. In some aspects, the sheet member 20 may be comprised of a fiberglass-reinforced paper stock in an appropriate thickness/weight/grade in relation to the combustible component disposed on the surface to be covered thereby. As shown in FIG. 3, the sheet member 20 may be interacted with the fire-retarding substance, for example, by dipping a roll 22 of the sheet member 20 into a vat 24 or other container filled with a suitable fire-retarding substance 26 which, in such an instance, may desirably be in a liquid solution form. Such physical interaction of the sheet member 20 with the fire-retarding substance 26 may be accomplished in various manners, for example, from maintaining the roll 22 within the vat 24 until the sheet member 20 is saturated with the fire-retarding substance 26, to submersing the roll 22 in multiple cycles into the fire-retarding substance 26 in the vat 24.

In another aspect, as shown, for example, in FIG. 4, the sheet member 20 may be unrolled from the roll 22 and directed, for example, through an arrangement of spray heads 28 configured to deliver the fire-retarding substance therethrough so as to spray the sheet member 20 with the fire-retarding substance 26. In other aspects, the fire-retarding substance 26 may be applied to the sheet member 20 by brushing, rolling, or in any other manner suitable to substantially evenly and uniformly distribute the fire-retarding substance 26 about the sheet member 20. The fire-retarding substance 26 may be applied to the sheet member 20 as a heavy coating to saturate the sheet member 20 with the fire-retarding substance 26, or in multiple coats.

In some aspects, other appropriate substances/materials/chemicals may be added or otherwise applied to the sheet member 20 to provide corresponding desirable characteristics. For example, a mold inhibitor may be included with the fire-retarding substance 26 for application to or inclusion in the sheet member 20. In other instances, water repellant, waterproofing, or an otherwise water resistant substance may be applied to or incorporated in the sheet member 20 such that the sheet member 20 exhibits water-resistive properties. In yet other instances, an insect-deterrent may be added to or included in the sheet member 20. Such an insect deterrent may comprise, for example, glass particles, glass fibers, glass slivers, glass shards, or any other suitable forms of glass elements, incorporated into the fiber mixture/slurry and/or a borate substance, applied to the sheet member 20, so as to provide a termite deterrent. In any instance, it may be preferable that any additional substances be suitably substantially uniformly distributed about the sheet member 20.

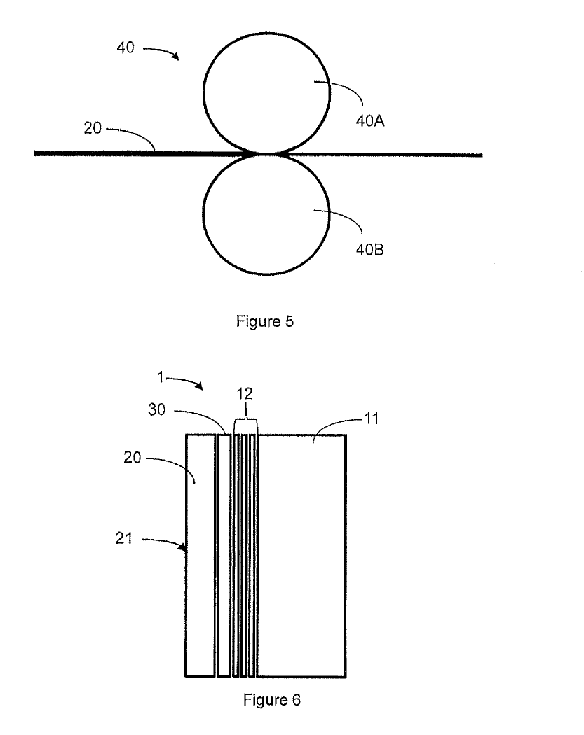

In instances where the fire-retarding substance 26 is applied to the sheet member 20, after the sheet member 20 has been formed, particular post-application steps may be performed in order to facilitate substantially even and uniform distribution of the fire-retarding substance 26 about the sheet member 20. For example, as shown in FIG. 5, the wetted sheet member 20 (i.e., the sheet member 20 having the fire-retarding substance 26 applied thereto) may be directed through a press device 40 comprising opposed rolls 40A, 40B arranged in a press nip configuration. In such an instance, the press nip may apply pressure to the sheet member 20 so as to remove excess fire-retarding substance 26 and/or to distribute the fire-retarding substance about the sheet member 20 to facilitate substantially even and uniform coverage. Where necessary, the wetted sheet member 20 may also be subjected to a drying process to remove any liquid aspect of the fire-retarding substance 26, while retaining efficacious aspects thereof in interaction with the sheet member 20 so as to render the sheet member 20 substantially fire-resistant and/or ignition-resistant. In this regard, such a drying process may implement, for example, one of heat, heated air (i.e., heated with combusted natural gas or other suitable fuel source), microwave energy, and/or infrared energy, as will be appreciated by one skilled in the art.

In some aspects, the fire-retarding substance 26 may be applied to the sheet member 20 in a suitable manner, for example, such that one gallon of the fire-retarding substance 26 may be applied to about 400 square feet of surface area. In other aspects, once formed, the sheet member 20 may desirably include between about 2% and about 30% solids content of the fire-retarding substance 26. That is, particular aspects of the disclosure require that a suitable amount of the fire-retarding substance 26 be included in or applied to the sheet member 20 such that the total solids content of each of the fire-retarding substance 26 within the resulting sheet member 20 is between about 2% and about 30%. In some instances, the amount of the fire-retarding substance 26 incorporated in or applied to the sheet member 20 may desirably be correlated with the extent of the fire resistance and/or thermal barrier properties exhibited by the sheet member 20.

According to another aspect of the present disclosure, the processed fire-resistant and/or ignition-resistant cellulose sheet member 20, once formed, may further be configured to be applied to the wall 1 to at least partially cover the outermost layer of the exposed combustible component (i.e., aesthetic treatment layer 12). In some instances, the sheet member 20 may be formed as a sheet having a predetermined length and width; or as a continuous sheet having a predetermined width, and which is later subdivided into segments of a desired length. As such, the sheet member 20 may be configured and arranged, as necessary, to cover the exposed combustible components of the wall 1.

Once the sheet member 20 is configured to at least partially cover the outermost layer of the exposed combustible component (i.e., aesthetic treatment layer 12), as appropriate, an adhesive material 30 is configured to be applied between the sheet member 20 and the wall 1 so as to secure the ignition-resistant cellulose sheet member 20 to the wall 1 as shown, for example, in FIG. 6. The adhesive material 30 may comprise, for example, glue, an epoxy, a resin, or any other material suitable for affixing the sheet member 20 to the wall 1. In some aspects, the adhesive material 30 may also have the fire-retarding substance incorporated therein, or may otherwise be non-flammable and/or ignition resistant. Where the adhesive material 30 also comprises the fire-retarding substance, the fire-retarding substance is preferably substantially uniformly distributed with respect to and throughout the adhesive material.

In some aspects, the sheet member 20 includes a major surface 21 (see, e.g., FIG. 6) adapted to receive an aesthetic surface treatment, and the sheet member 20 is applied to the wall 1 such that the major surface is exposed. Further, the sheet member 20 is affixed to or otherwise engaged with the wall 1, whether through use of the adhesive material 30 or otherwise, so as to substantially prevent atmospheric oxygen from interacting with the underlying combustible component (i.e., aesthetic treatment layer 12) and thereby minimizing or otherwise preventing ignition of the combustible component. That is, the sheet member 20 may be configured to provide fire and/or ignition resistance with respect to the wall 1 by essentially encapsulating any combustible layers (i.e., paint and/or wall paper) under the fire resistant/ignition resistant sheet member 20. In some instances, the sheet member 20 may also be configured to provide a thermal barrier to reduce heat transfer therethrough to the underlying combustible component(s) in the event of a fire, so as to further reduce the risk that the underlying combustible components will ignite or combust. The sheet member 20 may also be configured to eliminate or reduce the spread of flame along the surface of the wall 1, by way of exhibiting “zero ignition” and/or “zero flame spread,” upon treatment or other interaction with the fire-retarding solution 26 (i.e., as opposed to merely controlling flame spread). In light of such aspects, one skilled in the art will appreciate that the sheet member 20 may be configured in many different manners such as, for example, as one of an encasement paper sheet member, a medium density fiber (MDF) board sheet member, and an oriented strand board (OSB) sheet member. Further, the major surface 21 of the sheet member 20 may be configured to provide a suitable surface for the resulting product to accept paints, stains, or other surface treatment for enhancing the aesthetic properties of the end product. One skilled in the art will further appreciate that, though the sheet member 20 is referred to herein as being comprised of a cellulose material, any other suitable material exhibiting the desired properties (i.e., absorbency) disclosed herein may also be desirable and capable of being implemented within the scope of the present disclosure.

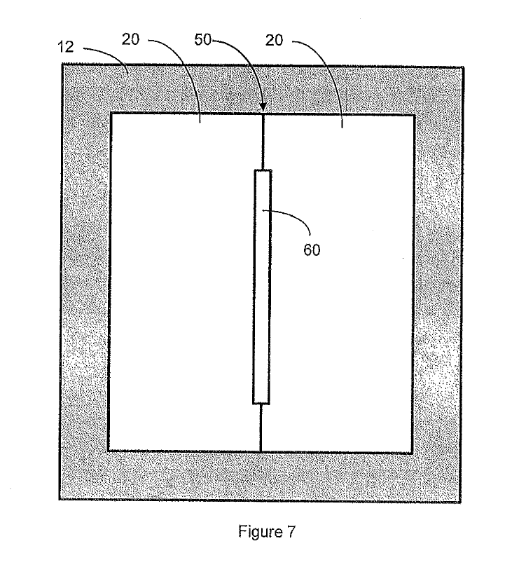

In some aspects, the sheet member(s) 20 are applied to the wall 1 such that seams 50 (see, e.g., FIG. 7) are formed or otherwise defined between adjacent sheet members 20. In such instances, in order to provide substantially complete “encapsulation” of the combustible components on the wall 1, aspects of the present disclosure contemplate that a seam-sealing element 60 may be configured to be applied to adjacent sheet members 20 secured to the wall 1 so as to cover the seam 50 and to cooperate with the sheet members 20 to cover the exposed combustible component (i.e., aesthetic treatment layer 12). The seam-sealing element (i.e., “drywall tape” and/or drywall “mud”) 60 may also be interacted with the fire-retarding substance 26, such that the fire-retarding substance 26 is substantially uniformly distributed thereabout, and is thus also rendered fire-resistant and/or ignition-resistant. As with the sheet member 20, the seam-sealing element 60 may also include a major surface adapted to receive an aesthetic surface treatment (i.e., paint and/or wallpaper) and, in such instances, may be configured to be applied to the adjacent sheet members 20 to cover the seam 50 therebetween while exposing the major surface of the seam-sealing element 60 for receiving the aesthetic surface treatment in conjunction with the sheet member(s) 20. Thus, in some aspects, the major surfaces of the sheet member(s) 20 and the seam-sealing element 60 are not configured to provide a cosmetic surface/wall covering, but merely provide a preface for or basis of a final decorative/cosmetic/aesthetic surface treatment.

Many modifications and other aspects of the disclosures set forth herein will come to mind to one skilled in the art to which these disclosures pertain having the benefit of the teachings presented in the foregoing descriptions and the associated drawings. For example, one skilled in the art that the sheet member disclosed herein readily lead to associated processes and methods for forming a fire resistant structure. More particularly, one skilled in the art will appreciate that, in some aspects, the sheet member may be applied to various other objects having exposed combustible components such as, for example, doors, cabinets, interior wall planking, exterior sheathing, cabinetry cores, cupboards, compounded cabinet door faces, or the like. Therefore, it is to be understood that the disclosures are not to be limited to the specific aspects disclosed and that modifications and other aspects are intended to be included within the scope of the appended claims. Although specific terms are employed herein, they are used in a generic and descriptive sense only and not for purposes of limitation.

That which is claimed:

1. A system for forming a fire resistant wall structure from a wall having an exposed combustible component, said system comprising:
a paper sheet member comprising cellulose fibers having a fire-retarding substance incorporated therein, the fire-retarding substance comprising one of a boron compound, a borate, an inorganic hydrate, a bromine compound, aluminum hydroxide, magnesium hydroxide, hydromagnesite, antimony trioxide, a phosphonium salt, ammonium phosphate, diammonium phosphate, and combinations thereof, the fire-retarding substance further being substantially uniformly distributed throughout the paper sheet member and interacted with the cellulose fibers so as to render the paper sheet member substantially ignition-resistant, the paper sheet member having a major surface adapted to receive an aesthetic surface treatment, and being configured to be applied to the wall such that the paper sheet member at least partially covers the exposed combustible component; and
an adhesive material configured to be applied between the paper sheet member and the wall so as to secure the paper sheet member to the wall, such that the major surface of the paper sheet member is exposed and so as to substantially prevent atmospheric oxygen from interacting with the combustible component.

2. A system according to claim 1, further comprising a seam-sealing element configured to be applied to adjacent paper sheet members secured to the wall and defining a seam therebetween, the seam-sealing element being configured to cover the seam and to cooperate with the paper sheet members to cover the exposed combustible component.

3. A system according to claim 2, wherein the seam-sealing element is interacted with the fire-retarding substance, and the fire-retarding substance is substantially uniformly distributed about the seam-sealing element, so as to render the seam-sealing element ignition-resistant.

4. A system according to claim 2, wherein the seam-sealing element includes a major surface adapted to receive an aesthetic surface treatment, and is configured to be applied to the adjacent paper sheet members to cover the seam therebetween such that the major surface of the seam-sealing element is exposed.

5. A system according to claim 1, wherein the adhesive material comprises the fire-retarding substance, the fire-retarding substance being substantially uniformly distributed with respect to the adhesive material so as to render the adhesive material ignition-resistant.

6. A system according to claim 1, wherein the paper sheet member includes between about 2% and about 30% solids content of the fire-retarding substance.

7. A system according to claim 1, wherein the cellulose fibers are processed from one of raw wood pulp, palm tree waste, waste fiber, waste paper, and waste board.

8. A system according to claim 1, wherein the fire-retarding substance comprises one of an aqueous fire-retarding solution, a nontoxic liquid fire-retarding solution, and a neutral pH liquid fire-retarding solution.

9. A system according to claim 1, wherein the paper sheet member further comprises one of a mold inhibitor, a water resistance treatment, and an insect deterrent.

10. A system according to claim 1, wherein the paper sheet member further comprises an insect deterrent, comprising one of glass particles and a borate substance, so as to provide a termite deterrent.

11. A method for forming a fire resistant wall structure from a wall having an exposed combustible component, said system comprising:
incorporating a fire-retarding substance into a paper sheet member comprising cellulose fibers, the fire-retarding substance comprising one of a boron compound, a borate, an inorganic hydrate, a bromine compound, aluminum hydroxide, magnesium hydroxide, hydromagnesite, antimony trioxide, a phosphonium salt, ammonium phosphate, diammonium phosphate, and combinations thereof, such that the fire-retarding substance is substantially uniformly distributed throughout the paper sheet member and interacted with the cellulose fibers so as to render the paper sheet member substantially ignition-resistant;
applying the paper sheet member to the wall such that the paper sheet member at least partially covers the exposed combustible component, the paper sheet member having a major surface adapted to receive an aesthetic surface treatment; and
applying an adhesive material between the paper sheet member and the wall so as to secure the paper sheet member to the wall, such that the major surface of the paper sheet member is exposed and so as to substantially prevent atmospheric oxygen from interacting with the combustible component.

12. A method according to claim 11, further comprising applying a seam-sealing element to adjacent paper sheet members, the paper sheet members being secured to the wall structure and defining a seam therebetween, such that the seam-sealing element covers the seam and cooperates with the paper sheet members to cover the exposed combustible component.

13. A method according to claim 12, further comprising interacting the seam-sealing element with the fire-retarding substance, such that the fire-retarding substance is substantially uniformly distributed about the seam-sealing element, so as to render the seam-sealing element ignition-resistant.

14. A method according to claim 12, wherein the seam-sealing element includes a major surface adapted to receive an aesthetic surface treatment, and the method further comprises applying the seam-sealing element to the adjacent paper sheet members to cover the seam therebetween such that the major surface of the seam-sealing element is exposed.

15. A method according to claim 11, further comprising interacting the adhesive material with the fire-retarding substance, such that the fire-retarding substance is substantially uniformly distributed with respect to the adhesive material, so as to render the adhesive material ignition-resistant.

16. A method according to claim 11, further comprising interacting the paper sheet member with the fire-retarding substance such that the paper sheet member includes between about 2% and about 30% solids content of the fire-retarding substance.

17. A method according to claim 11, further comprising processing one of raw wood pulp, palm tree waste, waste fiber, waste paper, and waste board, to form the cellulose fibers.

18. A method according to claim 11, further comprising interacting the paper sheet member with a fire-retarding substance comprising one of an aqueous fire-retarding solution, a nontoxic liquid fire-retarding solution, and a neutral pH liquid fire-retarding solution.

19. A method according to claim 11, further comprising interacting the paper sheet member with one of a mold inhibitor, a water resistance treatment, and an insect deterrent.

20. A method according to claim 11, further comprising interacting the paper sheet member with an insect deterrent, comprising one of glass particles and a borate substance, so as to provide a termite deterrent.
